(19) United States
(12) Patent Application Publication
(10) Pub. No.: US 2010/0279661 A1
(43) Pub. Date: Nov. 4, 2010

(54) PORTABLE ELECTRONIC DEVICE

(75) Inventors: Akihiro Furuta, Kanagawa (JP); Masaaki Suzuki, Kanagawa (JP); Misako Hirai, Kanagawa (JP); Miho Kamasu, Kanagawa (JP)

Correspondence Address: MCDERMOTT WILL & EMERY LLP, 600 13TH STREET, NW, WASHINGTON, DC, 20005-3096, US

(73) Assignee: PANASONIC CORPORATION, OSAKA (JP)

(21) Appl. No.: 12/837,056

(22) Filed: Jul. 15, 2010

Related U.S. Application Data
(63) Continuation of application No. PCT/JP2008/002182, filed on Aug. 8, 2008.

(30) Foreign Application Priority Data
Jan. 17, 2008 (JP) P2008-007972

(51) Int. Cl. H04W 68/00

(52) U.S. Cl. 455/412.2; 455/567

(57) ABSTRACT

A portable electronic device for receiving an incoming call from an external network, includes an incoming call indication unit configured to indicate the incoming call, an illuminance measurement unit configured to measure illuminance of a peripherally of the portable electronic device, an acceleration detection unit configured to detect an acceleration of the portable electronic device, and a status determination unit configured to determine a status of the portable electronic device in accordance with the acceleration detected by the acceleration detection unit and the illuminance measured by the illuminance measurement unit. When the status determination unit determines that the acceleration detected by the acceleration detection unit is greater than a threshold value and a change in the illuminance measured by the illuminance measurement unit is greater than a predetermined value, the status determination unit controls the incoming call indication unit to change an output indicating the incoming call.

### TECHNICAL FIELD

The present invention relates to a portable electronic device that outputs a ring tone when received an incoming call from an external network.

### BACKGROUND

When a portable phone is held in a bag, a briefcase, and the like, it is hard to hear a ring tone from the portable phone. Patent Document 1 describes a portable phone having an optical sensor for detecting ambient brightness. Since the portable phone automatically changes a ring tone according to the ambient brightness, the user can ascertain an incoming call without fail.

Patent Document 1: JP-A-9-121236

In the above-described portable phone, the optical sensor detects the ambient brightness. Therefore, it is impossible to distinguish between a brightness change result from the portable phone being taken out of or put into a bag, a briefcase, and the like and a brightness change result from activation or deactivation of illumination of a room. Further, when the portable phone is held in the bag, the briefcase, and the like, a volume of a ring tone is automatically set to a high level. However, when the portable phone outputting the ring tone is taken out of the bag, the briefcase, and the like, the tone may pose inconvenient to those around a user.

### SUMMARY

An objective of the present invention is to provide a portable electronic device that enables enhancement of convenience and reducing of user's stress.

According to an aspect of the present invention, there is provided a portable electronic device for receiving an incoming call from an external network, comprising:

an incoming call indication unit configured to indicate the incoming call;

an illuminance measurement unit configured to measure illuminance of a peripherally of the portable electronic device;

an acceleration detection unit configured to detect an acceleration of the portable electronic device; and

a status determination unit configured to determine a status of the portable electronic device in accordance with the acceleration detected by the acceleration detection unit and the illuminance measured by the illuminance measurement unit,

wherein when the status determination unit determines that the acceleration detected by the acceleration detection unit is greater than a threshold value and a change in the illuminance measured by the illuminance measurement unit is greater than a predetermined value, the status determination unit controls the incoming call indication unit to change an output indicating the incoming call.

Preferably, the incoming call indication unit includes a ring tone output unit that outputs a ring tone at a time of receiving the incoming call, and when the status determination unit determines, during the portable electronic device receives the incoming call, that the acceleration detected by the acceleration detection unit is greater than the threshold value, a change in the illuminance measured by the illuminance measurement unit is greater than the predetermined value, and the illuminance changes from darkness to brightness, the status determination unit controls the ring tone output unit so as to mute or reduce the ring tone.

Preferably, the portable electronic device further includes a control unit configured to change the portable electronic device to an absence mode when a responding operation is not performed after a predetermined period has elapsed since the incoming call is received. When the status determination unit determines, during the portable electronic device receives the incoming call, that the acceleration detected by the acceleration detection unit is greater than the threshold value, a change in the illuminance measured by the illuminance measurement unit is greater than the predetermined value, and the illuminance changes from darkness to brightness, the status determination unit commands the control unit to extend a time during which the change to the absence mode is performed or not to perform the change to the absence mode.

Preferably, the portable electronic device further includes a time count unit configured to count a time, and a display unit configured to display a text or a graphic. When the status determination unit determines that the acceleration detected by the acceleration detection unit is greater than the threshold value, a change in the illuminance measured by the illuminance measurement unit is greater than the predetermined value, and the illuminance changes from darkness to brightness, the status determination unit displays on the display unit a time counted by the time count unit.

Preferably, in the portable electronic device, when the status determination unit determines, during the portable electronic device receives the incoming call, that the acceleration detected by the acceleration detection unit is greater than the threshold value, a change in the illuminance measured by the illuminance measurement unit is greater than the predetermined value, and the illuminance changes from brightness to darkness, the status determination unit controls the incoming call indication unit so as to stop the output indicating the incoming call.

In the portable electronic device, the incoming call indication unit includes a vibration unit that vibrates the portable electronic device at a time of receiving the incoming call. When the status determination unit determines, during the portable electronic device receives the incoming call, that the acceleration detected by the acceleration detection unit is greater than the threshold value, a change in the illuminance measured by the illuminance measurement unit is greater than the predetermined value, and the illuminance changes from brightness to darkness, the status determination unit controls the incoming call indication unit so as to stop the output except vibration by the vibration unit.

The portable electronic device further includes a missed call recording unit configured to records a missed call or a receipt of a mail. When the status determination unit determines that the acceleration detected by the acceleration detection unit is greater than the threshold value, a change in the illuminance measured by the illuminance measurement unit is greater than the predetermined value, and the change in the illuminance changes from darkness to brightness, the status determination unit controls the incoming call indication unit so as to perform an outputting operation by light, sound or vibration if the missed call or the receipt of the mail is recorded in missed call recording unit.

The portable electronic device according to the present invention changes the output indicating the incoming call in accordance with the change in the illuminance detected by the illuminance measurement unit and the acceleration detected by the acceleration detection unit, and hence it becomes possible to assist user's operation and reduce user's stress.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing a portable phone of a first embodiment;

FIG. 2 is a flowchart showing a determination made by a status determination unit using data from an acceleration sensor;

FIG. 3 is a flowchart showing a determination made by the status determination unit 125 using data from an optical sensor; and

FIG. 4 is a flowchart for determining a status of a portable phone according to respective results obtained from the respective flowcharts shown in FIGS. 2 and 3.

### DETAILED DESCRIPTION OF EXEMPLARY EMBODIMENTS

Embodiments of the present invention are hereunder described by reference to the drawings.

### First Embodiment

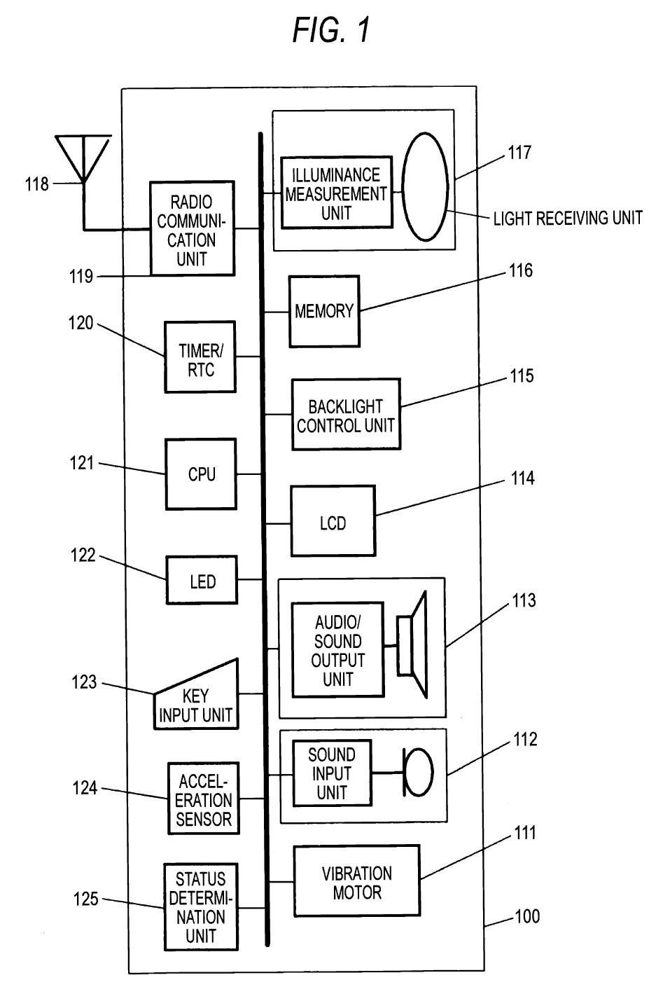

FIG. 1 is a block diagram showing a portable phone according to a first embodiment. As shown in FIG. 1, a portable phone 100 includes a CPU 121, memory 116, an antenna 118, a radio communication unit 119, an optical sensor 117, an acceleration sensor 124, a timer/RTC 120, an LCD 114, a backlight control unit 115, a key input unit 123, a sound input unit 112, an audio/sound output unit 113, a vibration motor 111, an LED 122, and a status determination unit 125.

The CPU 121 controls entirety of the portable phone 100. The memory 116 is a storage medium. The portable phone 100 is operated based on a command code stored in the memory 116. The antenna 118 and the radio communication unit 119 transmit or receive a radio wave to and from a phone network. The optical sensor 117 has a light receiving unit that receives light and an illuminance measurement unit that measures light intensity as illuminance. Data indicating the illuminance measured by the optical sensor 117 is delivered to the status determination unit 125.

The acceleration sensor 124 detects an acceleration occurred when the user moves the portable phone 100. Data indicating the acceleration detected by the acceleration sensor 124 is delivered to the status determination unit 125. A sensor for detecting motion of the portable phone 100 may also be used instead of the acceleration sensor 124. The timer/RTC 120 periodically measures a time and stores a preset time.

The LCD 114 is a display device. The backlight control unit 115 controls activation/deactivation of a backlight illuminating the LCD 114 from back and an amount of light quantity of the backlight. The LCD 114 and the backlight control unit 115 may be provided in plural respectively. In this case, illumination of the backlight on the LCDs 114 is separately controlled, and the respective LCDs 114 are displayed.

The key input unit 123 is an interface through which the user operates the portable phone 100. The sound input unit 112 is a device for inputting sound. The audio sound output unit 113 outputs a ring tone and music and outputs a voice received during operation of the phone from a speaker. The vibration motor 111 is a motor for vibrating the portable phone 100. An incoming call or occurrence of another event is indicated to the user by a vibration of the portable phone 100 performed by the vibration motor 111. The LED 122 indicates an incoming call or occurrence of another event to the user by lighting or blinking. Incidentally, the word “incoming call” includes receipt of a mail, or the like, as well as a receipt of a call.

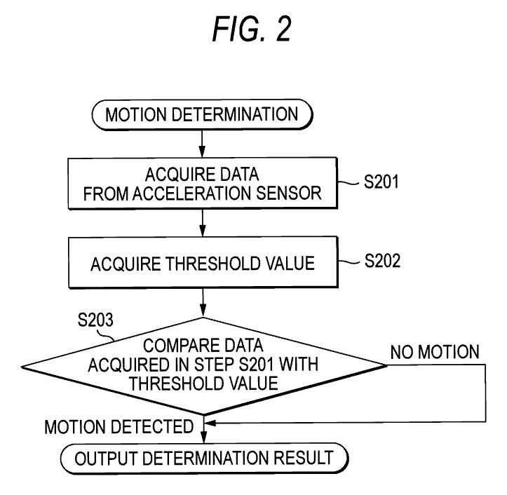

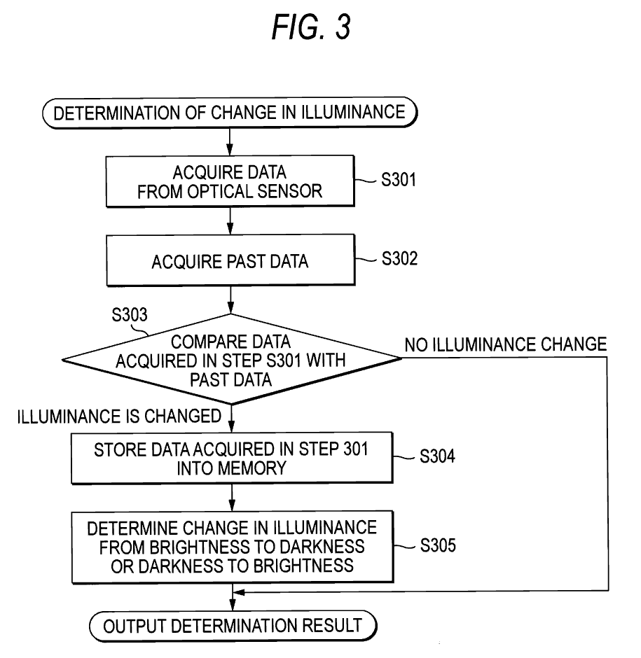

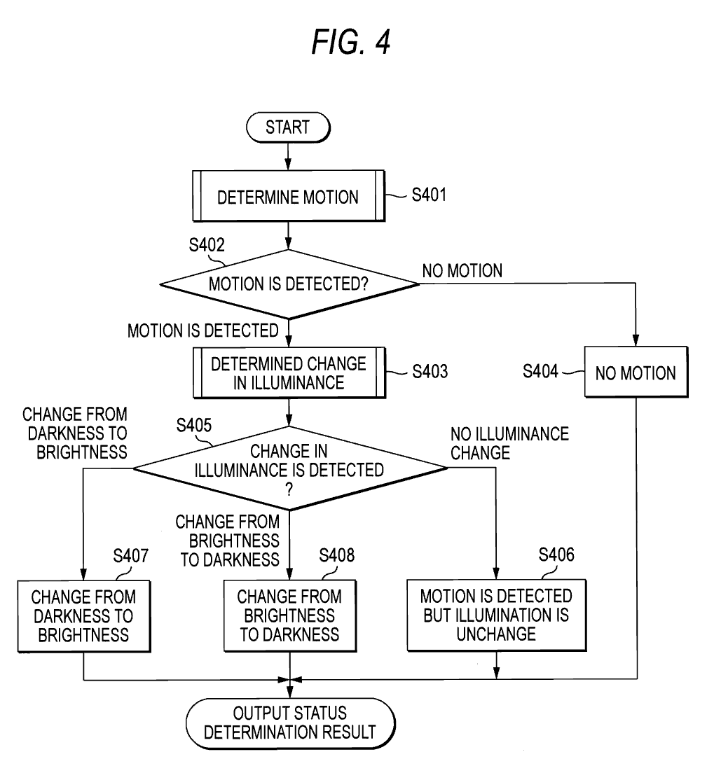

The status determination unit 125 determines a status of the portable phone 100 by use of respective sets of data sent from the acceleration sensor 124 and the optical sensor 117. FIG. 2 is a flowchart showing a determination made by the status determination unit 125 by use of the data from the acceleration sensor 124. FIG. 3 is a flowchart showing a determination made by the status determination unit 125 by use of the data from the optical sensor 117. FIG. 4 is a flowchart for determining the status of the portable phone 100 according to respective results obtained from the respective flowcharts shown in FIGS. 2 and 3. As shown in FIGS. 2 through 4, the status determination unit 125 determines a status of the portable phone 100 when the portable phone 100 is moved from a bright location to a dark location or from the dark location to the bright location, from the respective sets of data sent from the optical sensor 117 and the acceleration sensor 124.

A determination whether motion/non-motion of the portable phone 100 made by the status determination unit 125 is described by reference to FIG. 2. In step S201, the data detected by the acceleration sensor 124 is acquired by the status determination unit 125. In step S202, a threshold value compared with the data acquired in step S201 is acquired, and the acquired threshold value is stored in the memory 116. In step S203, the status determination unit 125 compares the data acquired in step S201 with the threshold value acquired in step S202, thereby determining whether or not the portable phone 100 has been moved. When the data acquired in step S201 is greater than the threshold value, the status determination unit 125 determines that the portable phone 100 has been moved. For instance, when the user takes the portable phone 100 out of the bag, the briefcase, or the like, the portable phone 100 is determined to have been moved in step S203.

By reference to FIG. 3, there is now described a determination as to a change in received light made by the status determination unit 125. In step S301, the status determination unit 125 acquires the data indicating the illuminance measured by the optical sensor 117. In step S302, the status determination unit 125 acquires the data stored in the memory 116 in the past. In step S303, the status determination unit 125 compares the data acquired in step S301 with the data acquired in step S302, thereby determining whether or not a change occurs in the illuminance. When a difference between a value indicated by the data acquired in step S301 and a value indicated by the data acquired in step S302 is greater than the threshold value, the status determination unit 125 determines that the change occurs in the illuminance. For instance, when the user takes the portable phone 100 out of the closed bag, the closed briefcase, or the like, or puts the portable phone in the bag, the briefcase, or the like, in a bright space, it is determined that the illumination changes in step S303.

When it is determined that the illumination is changed in step S303, the data acquired in step S301 is stored in the memory 116 in step S304. In step S305, it is determined that the illuminance is changed from brightness to darkness or the illumination changes from darkness to brightness. When a value represented by the data acquired in step S301 is equal to or less than a value represented by the data acquired in step S302, the status determination unit 125 determines that the illuminance changes from brightness to darkness. On the contrary, when the value represented by the data acquired in step S301 is greater than the value represented by the data acquired in step S302, the status determination unit 125 determines that the illuminance changes from darkness to brightness. Meanwhile, when it is determined that the illumination is unchanged in step S303, a determination result indicating “no change” is output.

A determination of the status of the portable phone 100 performed by the status determination unit 125 is now described by reference to FIG. 4. In step S401, the motion determination represented by the flowchart shown in FIG. 2 is performed, and a determination is made in step S402 as to whether or not motion occurs. When “no motion” is determined, processing proceeds to step S404, and “no motion” is output as a status determination result. In the meantime, when “motion” of the portable phone 100 is determined, processing proceeds to step S403.

In step S403, a determination as to the change in the illuminance represented by the flowchart shown in FIG. 3 is performed. In step S405, it is determined whether or not a change occurs in the illuminance and whether the illuminance is changed from brightness to darkness or from darkness to brightness. When “no illumination change” is determined, processing proceeds to step S406, and “motion is detected but illuminance is unchanged” is output as the status determination result. On the contrary, when it is determined that the illuminance is changed from darkness to brightness “change from darkness to brightness”, processing proceeds to step S407, and “change from darkness to brightness” is output as the status determination result. In the meantime, when it is determined that the illuminance is changed from brightness to darkness “change from brightness to darkness”, processing proceeds to step S408, and “change from brightness to darkness” is output as the status determination result.

In the portable phone 100 of the above described embodiment, when the status determination unit 125 determines that the portable phone 100 is moved from a dark location to a bright location (“motion is detected” and a “change from darkness to brightness”) during the portable phone 100 receives an incoming call, a ring tone is muted or a volume of the ring tone is reduced. Therefore, when the portable phone 100 is taken out of the bag, the briefcase, or the like, no inconvenience is posed to those around the user.

In the portable phone 100 of the present embodiment, when a responding operation is not performed until a predetermined period has elapsed since the incoming call is received, the CPU 121 controls the portable phone 100 to change to an absence mode, that is a telephone answering state or a record message state. However, when the status determination unit 125 determines that the portable phone 100 is moved from the dark location to the bright location (“motion is detected” and “change from darkness to brightness”) during the portable phone 100 receives the incoming call, the status determination unit 125 commands the CPU 121 to extend a time during which the change to the absence mode is performed or not to perform the change to the absence mode.

Further, when the status determination unit 125 determines that the portable phone 100 is moved from the dark location to the bright location (“motion is detected” and “change from darkness to brightness”), the time stored in the timer/RTC 120 is displayed on the LCD 114. The amount of light lighting the LCD 114 is controlled by the backlight control unit 115 according to the illuminance measured by the optical sensor 114. Power consumption is reduced by performance of the control operation.

When the status determination unit 125 determines that the portable phone 100 is moved from the bright location to the dark location (“motion is detected” and “change from brightness to darkness”) during the portable phone 100 receives the incoming call, all incoming call operations, such as generation of a ring tone performed by the audio/sound output unit 113, vibration generated by the vibration motor 111, lighting, blinking, or the like, of the LED 122, are stopped. Incidentally, only vibration performed by the vibration motor 111 may be allowed.

When the portable phone 100 is changed to a missed call state in which an incoming call is not responded or an unread state in which a received mail, or the like, has not been read, the LED 122 is blinked or the like. However, when the status determination unit 125 determines that the portable phone 100 is moved from the dark location to the bright location (“motion is detected” and “change from darkness to brightness”) while the portable phone 100 is in the missed call state or the unread state of the mail, generation of sound and vibration, lighting or blinking, or the like, is performed in order to inform the user of the status. The missed call status and the unread status of the mail are recorded in the memory 116.

Although the present invention has been described in detail by reference to the specific embodiments, as well, it is manifest to those skilled in the art that the present invention be susceptible to various alterations or modifications without departing the spirit and scope of the present invention.

The disclosure of Japanese Patent Application No. JP-2008-007972 filed on Jan. 17, 2008 including specification, drawings and claims is incorporated herein by reference in its entirety.

### INDUSTRIAL APPLICABILITY

The portable electronic device of the present invention is useful as a portable phone, or the like, that performs optimum assistance of a user according to a situation of the user and operation, thereby enhancing user's operability.

### DESCRIPTIONS OF THE REFERENCE NUMERALS AND SYMBOLS

100 PORTABLE PHONE
111 VIBRATION MOTOR
112 SOUND INPUT UNIT
113 AUDIO/SOUND OUTPUT UNIT
114 DISPLAY DEVICE
115 BACKLIGHT CONTROL UNIT
116 MEMORY
117 OPTICAL SENSOR
118 ANTENNA
119 RADIO COMMUNICATION UNIT
120 TIMER/RTC
121 CPU
122 LED
123 KEY INPUT UNIT
124 ACCELERATION SENSOR
125 STATUS DETERMINATION UNIT

What is claimed is:

1. A portable electronic device for receiving an incoming call from an external network, comprising:
an incoming call indication unit configured to indicate the incoming call;
an illuminance measurement unit configured to measure illuminance of a peripherally of the portable electronic device;
an acceleration detection unit configured to detect an acceleration of the portable electronic device; and
a status determination unit configured to determine a status of the portable electronic device in accordance with the acceleration detected by the acceleration detection unit and the illuminance measured by the illuminance measurement unit,
wherein when the status determination unit determines that the acceleration detected by the acceleration detection unit is greater than a threshold value and a change in the illuminance measured by the illuminance measurement unit is greater than a predetermined value, the status determination unit controls the incoming call indication unit to change an output indicating the incoming call.

2. The portable electronic device according to claim 1, wherein the incoming call indication unit includes a ring tone output unit that outputs a ring tone at a time of receiving the incoming call; and
wherein when the status determination unit determines, during the portable electronic device receives the incoming call, that the acceleration detected by the acceleration detection unit is greater than the threshold value, a change in the illuminance measured by the illuminance measurement unit is greater than the predetermined value, and the illuminance changes from darkness to brightness, the status determination unit controls the ring tone output unit so as to mute or reduce the ring tone.

3. The portable electronic device according to claim 1, further comprising:
a control unit configured to change the portable electronic device to an absence mode when a responding operation is not performed after a predetermined period has elapsed since the incoming call is received,
wherein, when the status determination unit determines, during the portable electronic device receives the incoming call, that the acceleration detected by the acceleration detection unit is greater than the threshold value, a change in the illuminance measured by the illuminance measurement unit is greater than the predetermined value, and the illuminance changes from darkness to brightness, the status determination unit commands the control unit to extend a time during which the change to the absence mode is performed or not to perform the change to the absence mode.

4. The portable electronic device according to claim 1, further comprising:
a time count unit configured to count a time; and
a display unit configured to display a text or a graphic,
wherein, when the status determination unit determines that the acceleration detected by the acceleration detection unit is greater than the threshold value, a change in the illuminance measured by the illuminance measurement unit is greater than the predetermined value, and the illuminance changes from darkness to brightness, the status determination unit displays on the display unit a time counted by the time count unit.

5. The portable electronic device according to claim 1, wherein, when the status determination unit determines, during the portable electronic device receives the incoming call, that the acceleration detected by the acceleration detection unit is greater than the threshold value, a change in the illuminance measured by the illuminance measurement unit is greater than the predetermined value, and the illuminance changes from brightness to darkness, the status determination unit controls the incoming call indication unit so as to stop the output indicating the incoming call.

6. The portable electronic device according to claim 5, wherein the incoming call indication unit includes a vibration unit that vibrates the portable electronic device at a time of receiving the incoming call, wherein, when the status determination unit determines, during the portable electronic device receives the incoming call, that the acceleration detected by the acceleration detection unit is greater than the threshold value, a change in the illuminance measured by the illuminance measurement unit is greater than the predetermined value, and the illuminance changes from brightness to darkness, the status determination unit controls the incoming call indication unit so as to stop the output except vibration by the vibration unit.

7. The portable electronic device according to claim 1, further comprising:
a missed call recording unit configured to records a missed call or a receipt of a mail,
wherein, when the status determination unit determines that the acceleration detected by the acceleration detection unit is greater than the threshold value, a change in the illuminance measured by the illuminance measurement unit is greater than the predetermined value, and the change in the illuminance changes from darkness to brightness, the status determination unit controls the incoming call indication unit so as to perform an outputting operation by light, sound or vibration if the missed call or the receipt of the mail is recorded in missed call recording unit.
